(19) United States
(12) Patent Application Publication
(10) Pub. No.: US 2025/0222574 A1
(43) Pub. Date: Jul. 10, 2025

(54) HUB REMOVAL DEVICE

(71) Applicant: Donald Anna, Boonville, NY (US)

(72) Inventor: Donald Anna, Boonville, NY (US)

(21) Appl. No.: 18/408,748

(22) Filed: Jan. 10, 2024

(51) Int. Cl. B25B 27/06

(52) U.S. Cl. CPC B25B 27/062

(57) ABSTRACT

A hub removal device for removing a hub assembly for a wheel of a vehicle away from a steering knuckle includes a puller plate which may be coupled to studs of the hub assembly and an actuating rod which is operable to threadedly engage the puller plate and push against a stub axle. A method of removing such a hub assembly using the device is also disclosed. The actuating rod may be rotated to advance the actuating rod through the puller plate and against the stub axle, which is attached to the steering knuckle. The puller plate pulls on the studs of the hub assembly, and the rotating rod pushes against the stub axle, resulting in removal of the hub assembly from the steering knuckle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hub removal tools and more particularly pertains to a new hub removal tool for removing a hub assembly for a wheel of a vehicle away from a steering knuckle via moving studs of the hub assembly with respect to a stub axle attached to the steering knuckle.

### (2) Description of Related Art Including Information Disclosed Under 37 CFR 1.97 and 1.98

The prior art discloses myriad hub removal tools which typically are structured to grab onto a flanged portion of the hub to pull the hub off a bearing. However, some hubs may not have a flange that may be grasped by such a tool, or users may want to simply use an alternative tool. The prior art fails to describe a hub removal device that uses a puller plate to couple to studs of a hub assembly and an actuator arm that is operable to push the puller plate away from a stub axle. The prior art also fails to describe support blocks that may assist in the operation of such a device by transferring a force through the stub axle to an axle housing through the support blocks.

### BRIEF SUMMARY OF THE INVENTION

An embodiment of the disclosure meets the needs presented above by generally comprising a puller plate which defines a central hole extending therethrough and has internal threads in the central hole. The puller plate also defines a plurality of stud holes which are radially spaced around the central hole. The plurality of stud holes is configured to align with studs of a hub assembly, and the puller plate is configured to couple to the studs of a hub assembly. An actuating rod has a first end, a second end, and external threads which are engageable with the internal threads of the central hole of the puller plate.

Another embodiment of the present invention includes a method of removing a hub assembly from a steering knuckle using the apparatus described above. The method includes coupling the puller plate to the studs of the hub assembly. Then an actuating rod is screwed into and through the central hole of the puller plate and through the hub assembly to a stub axle. The stub axle is coupled to the steering knuckle via an axle housing. The actuating rod is rotated further to advance the actuating rod via the threading engagement with the puller plate against the stub axle, urging the puller plate away from the stub axle. The puller plate thereby exerts a pulling force on the studs of the hub assembly away from the steering knuckle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a kit view of a hub removal device according to an embodiment of the disclosure with a plurality of nuts of the hub removal device removed.

FIG. 2 is a cross-section view of a stud extender of a subset of a plurality of stud extenders an embodiment of the disclosure. The view is taken from Line 2-2 in FIG. 1.

FIG. 3 is a cross-section view of another stud extender of another subset of a plurality of stud extenders of an embodiment of the disclosure. The view is taken from Line 3-3 in FIG. 1.

FIG. 4 is a perspective view of a puller plate of an embodiment of the disclosure.

FIG. 5 is a perspective view of a puller plate of an embodiment of the disclosure.

FIG. 6 is a perspective view of a stud extender of an embodiment of the disclosure.

FIG. 7 is a perspective view of an actuating rod of an embodiment of the disclosure.

FIG. 8 is a perspective view of a support block of an embodiment of the disclosure.

FIG. 9 is a perspective exploded view of a plurality of stud extenders in use with a hub assembly of an embodiment of the disclosure. The hub assembly is a first hub assembly.

FIG. 10 is a perspective exploded view of a puller plate and a plurality of nuts of an embodiment of the disclosure in use with the first hub assembly after attaching the stud extenders to the first hub assembly.

FIG. 11 is a perspective view of an embodiment of the disclosure mounted on the first hub assembly.

FIG. 12 is a perspective exploded view of an embodiment of the disclosure in use with a hub assembly. The hub assembly is a second hub assembly.

FIG. 13 is an exploded view of an embodiment of the disclosure in use with a hub assembly.

FIG. 14 is an in-use view of an embodiment of the disclosure with the embodiment positioned immediately prior to removing a hub assembly from a steering knuckle.

FIG. 15 is an in-use view of an embodiment of the disclosure with the embodiment being operated to move the hub assembly off of the steering knuckle.

FIG. 16 is a front view of an embodiment of the disclosure mounted to the first hub assembly.

FIG. 17 is a front view of an embodiment of the disclosure mounted to the second hub assembly.

### DETAILED DESCRIPTION OF THE INVENTION

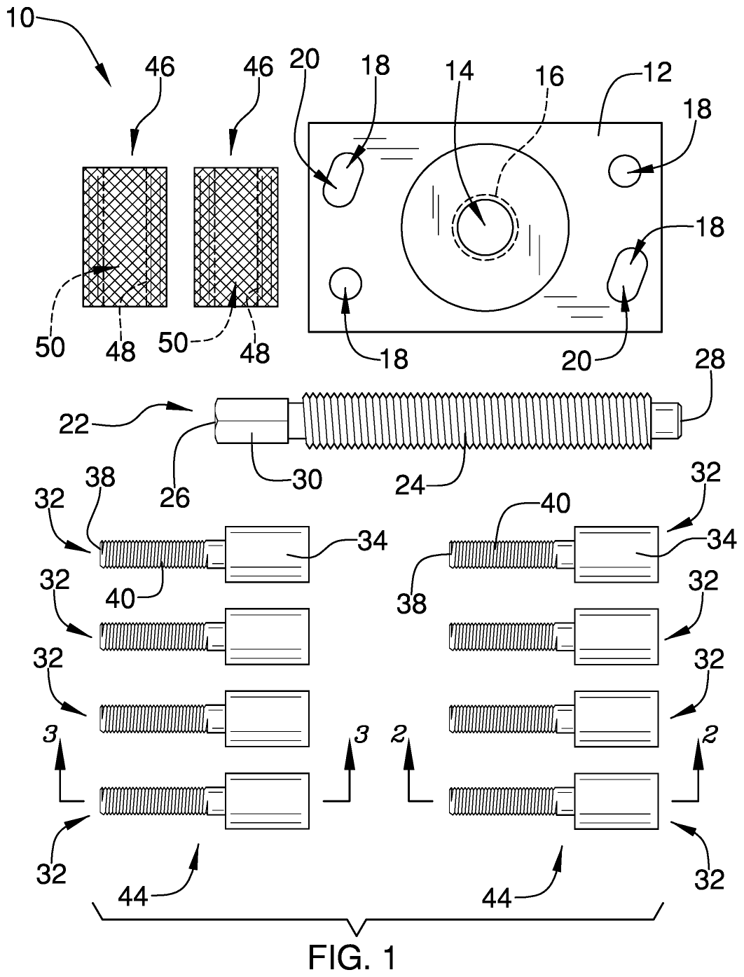

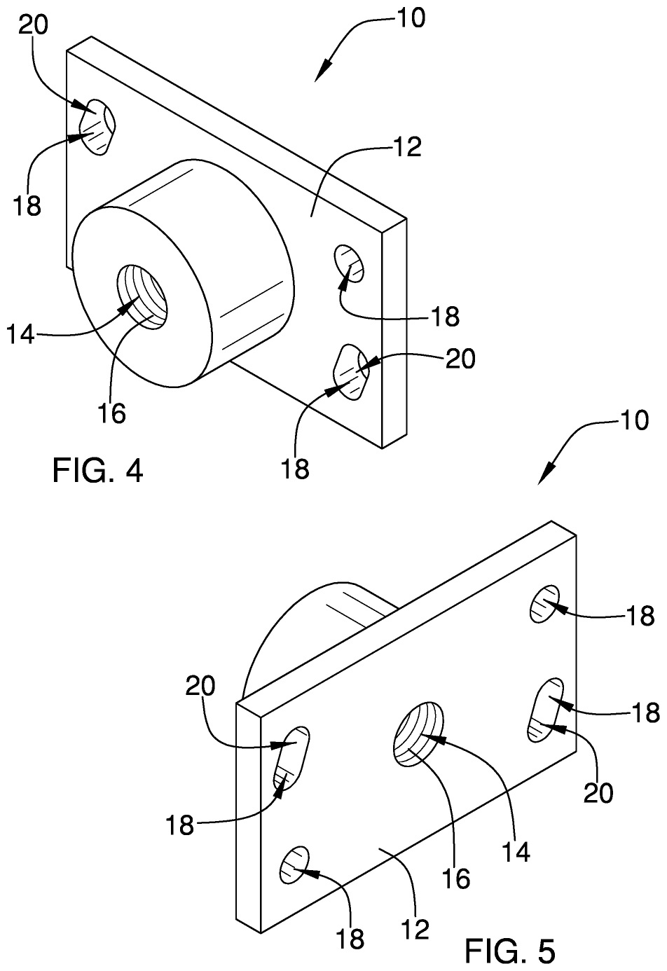

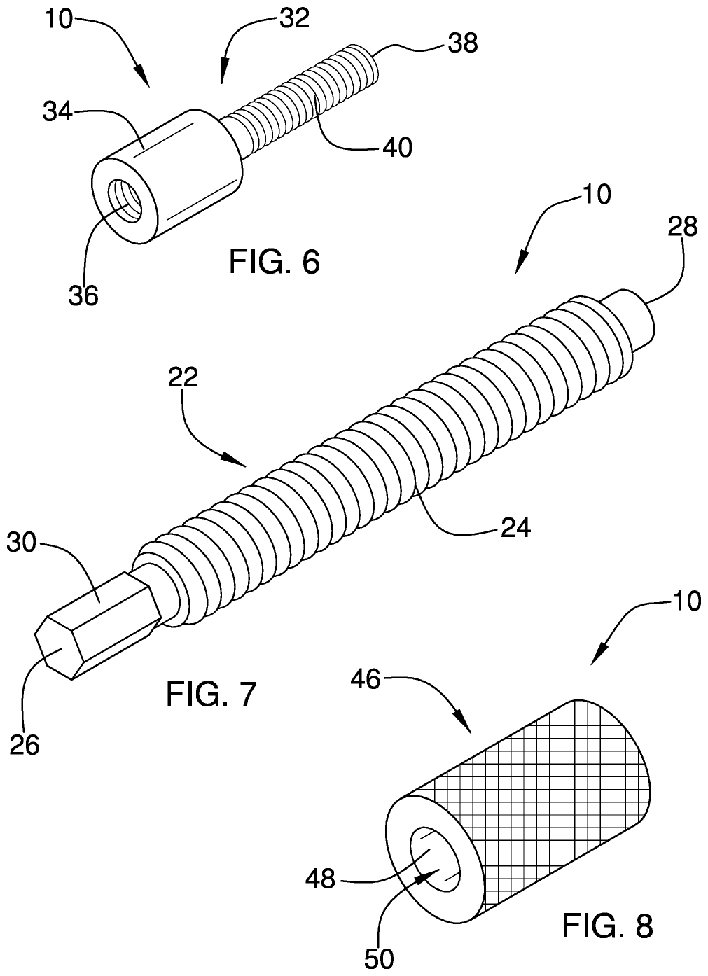

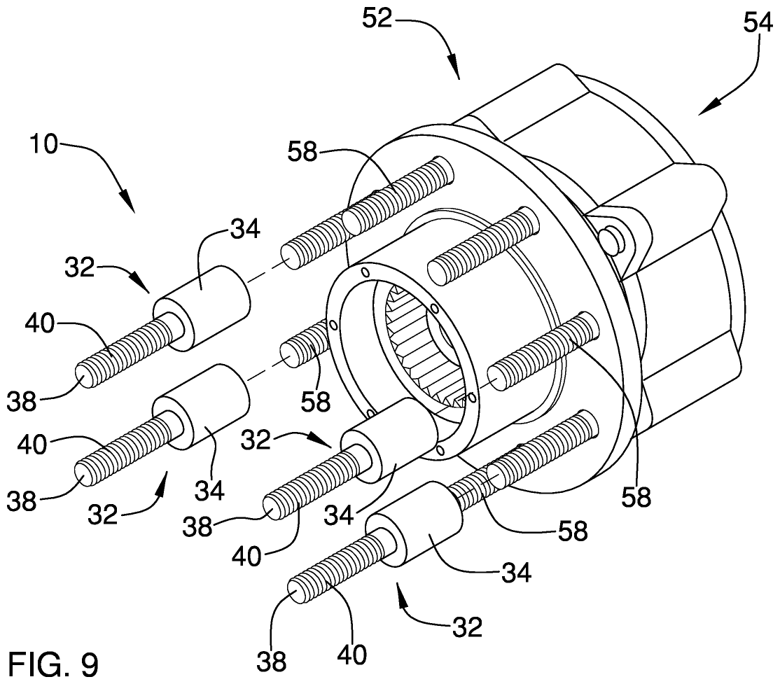

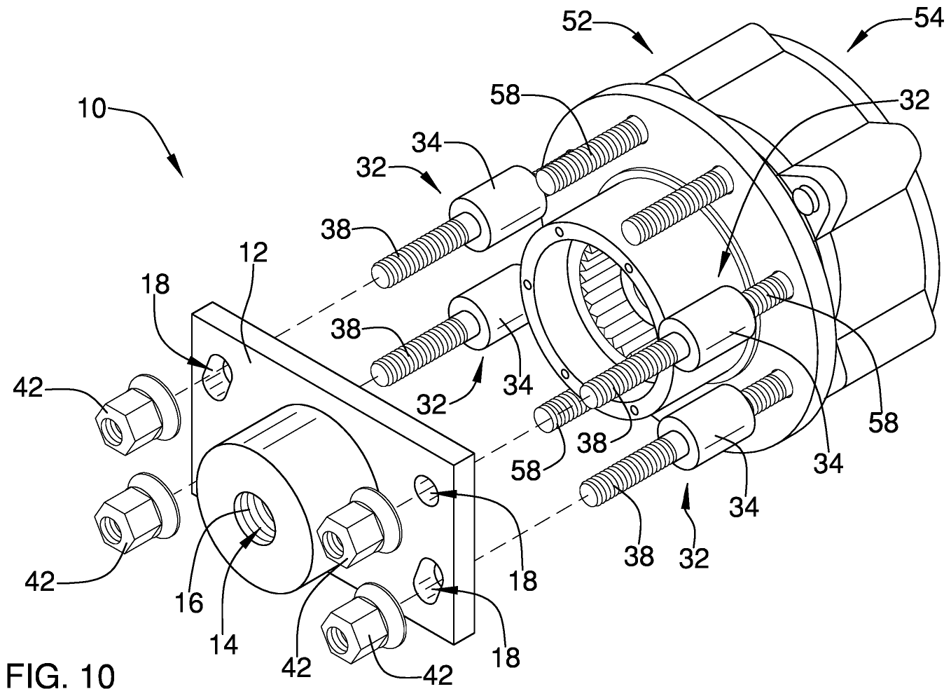

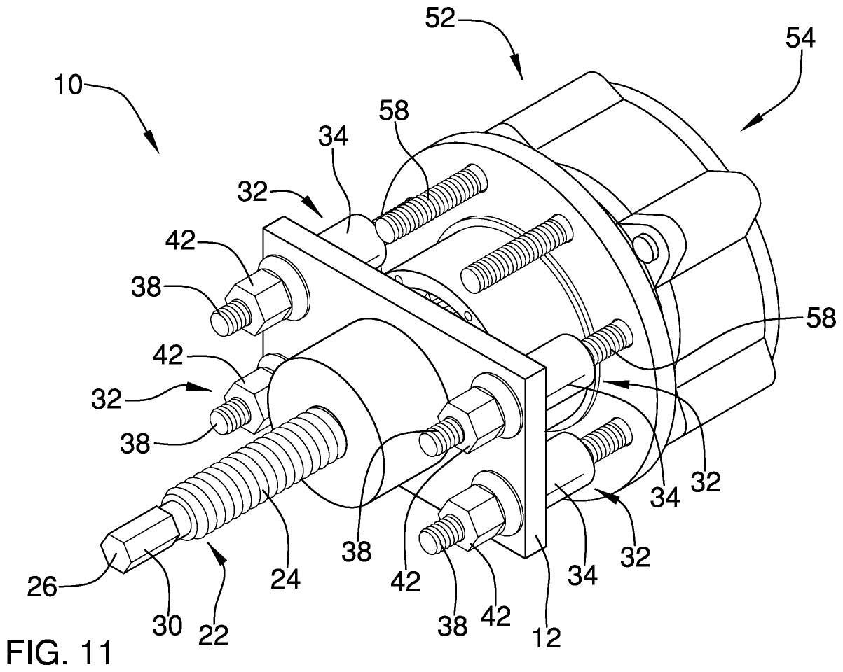

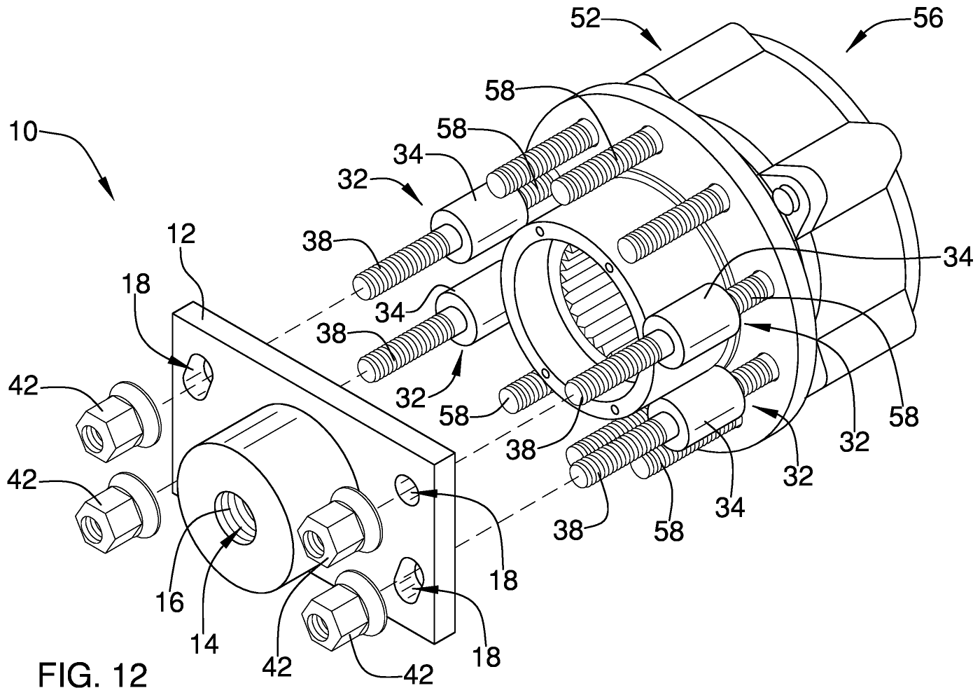

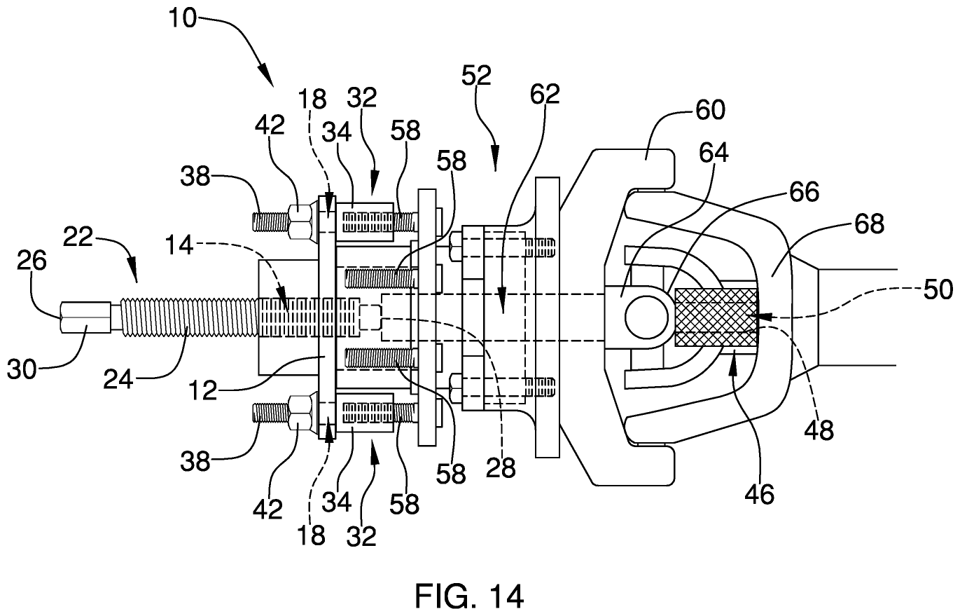

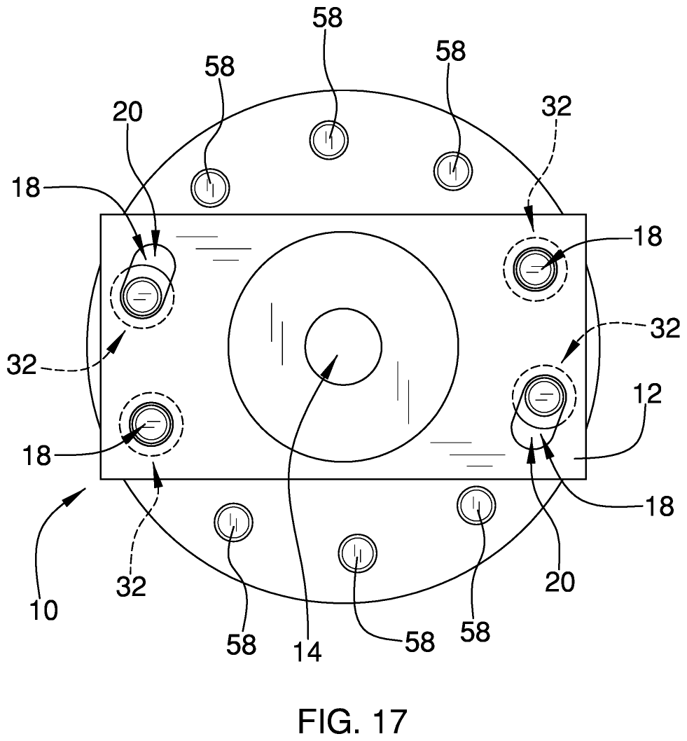

With reference now to the drawings, and in particular to FIGS. 1 through 17 thereof, a new hub removal tool embodying the principles and concepts of an embodiment of the disclosure and generally designated by the reference numeral 10 will be described.

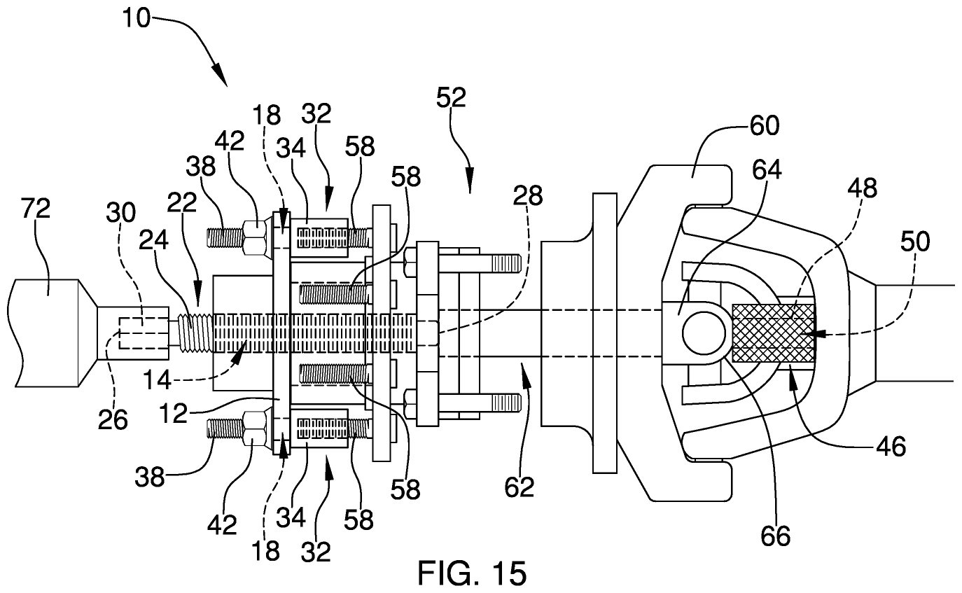

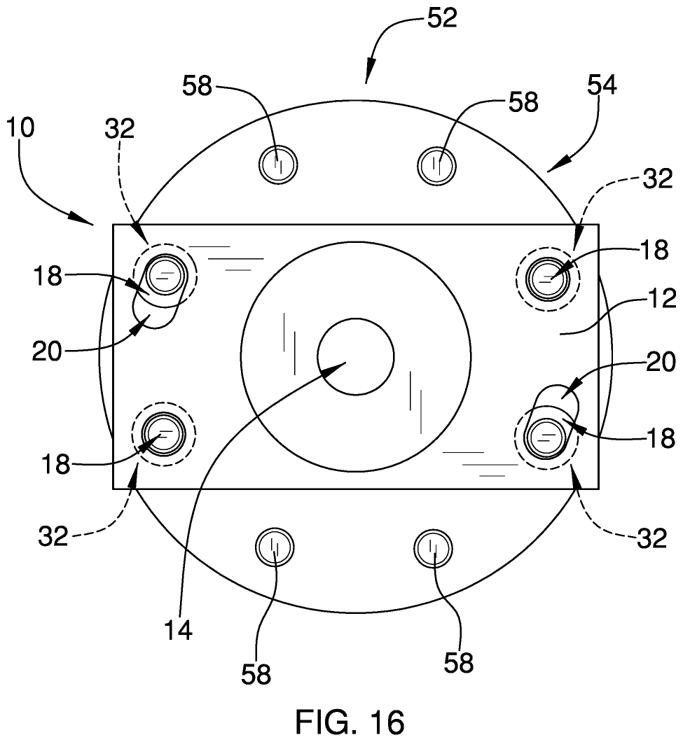

As best illustrated in FIGS. 1 through 17, the hub removal device 10 generally comprises a puller plate 12 which defines a central hole 14 that extends therethrough and has internal threads 16 in the central hole 14. The puller plate 12 also defines a plurality of stud holes 18 which are radially spaced around the central hole 14. The stud holes 18 are arranged to facilitate alternately mounting the puller plate 12 to different hub assemblies 52 that have different arrangements of studs 58. In particular, the puller plate 12 may mount to hub assemblies 52 comprising studs 58 that have different radial spacings around central axes of their hub assemblies 52. The plurality of stud holes 18 includes a set of slots 20 which are elongated radially around the central hole 14 to facilitate the alternate mounting as described. The Figures generally show the puller plate 12 mounting to four of the studs 58 of a first hub assembly 54 and alternately four of the studs 58 of a second hub assembly 56. With reference to FIGS. 15 and 16, the slots 20 receive the respective studs 58 of the first and second hub assemblies 52 in different locations along the slot 20 given their different radial spacings.

In other embodiments, the puller plate 12 may attach to a different number of studs 58 suitable for the purpose of removing the respective hub assembly 52 from an attached steering knuckle 60. Alternate embodiments of the present disclosure may include differently arranged or shaped stud holes 18 for mounting to the studs 58 of different hub assemblies 52.

An actuating rod 22 has external threads 24 which are engageable with the internal threads 16 of the central hole 14 of the puller plate 12. The actuating rod 22 has a first end 26 and a second end 28. At the first end 26, the actuating rod 22 comprises a wrench engagement portion 30 shaped to receive a torque from a driver tool 72, such as an impact driver, wrench, or the like, to screw the actuating rod 22 through the central hole 14 of the puller plate 12. The wrench engagement portion 30 has a hexagonal cross-section but may have other cross-sections suitable for receiving the torque.

A plurality of stud extenders 32 and a plurality of nuts 42 are operable to attach the puller plate 12 to the plurality of studs 58. The stud extenders 32 are receivable through the stud holes 18 of the puller plate 12. Each stud extender 32 has a receiver portion 34 and an insertion portion 38 that are coupled to and axially aligned with each other. The receiver portion 34 of each stud extender 32 has internal threads 36 configured to threadedly engage a selected stud 58 of one of the different hub assemblies 52. The insertion portion 38 has external threads 40 and is sized to be received through a selected one of the stud holes 18 of the puller plate 12. The nuts 42 are then threadedly engageable to the plurality of stud extenders 32 to mount the puller plate 12 to the stud extenders 32. In other embodiments, the nuts 42 may secure the puller plate 12 directly to the studs 58 of a selected hub assembly 52.

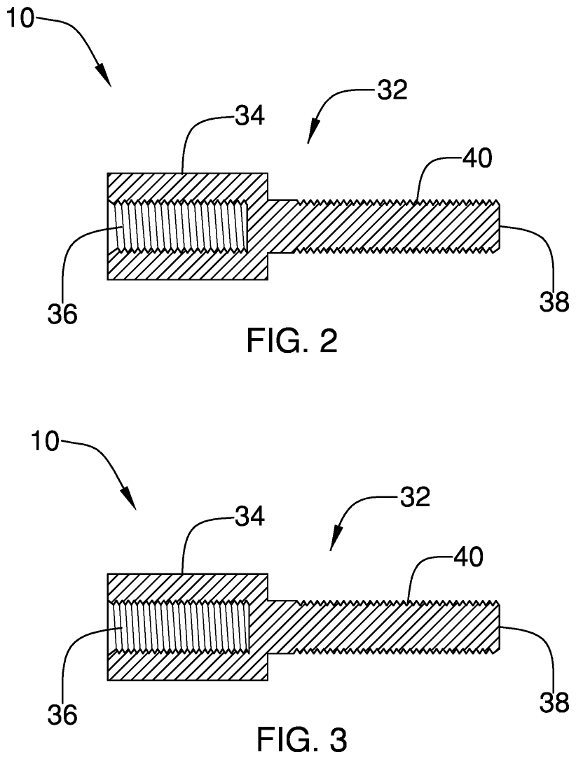

The plurality of stud extenders 32 includes multiple subsets 44 of stud extenders 32, wherein each stud extender 32 of each subset 44 is configured to couple to one of the studs 58 of a corresponding hub assembly 52 of the different hub assemblies 52. FIGS. 2 and 3 depict stud extenders 32 from two different subsets 44 which have different thread pitches for the internal threads 36 of their receiver portions 34. In other embodiments, various other dimensions of the stud extenders 32 of different subsets 44 may be different, such as bore size of the interior of the receiver portion 34, diameter of the insertion portion 38, thread type, and the like.

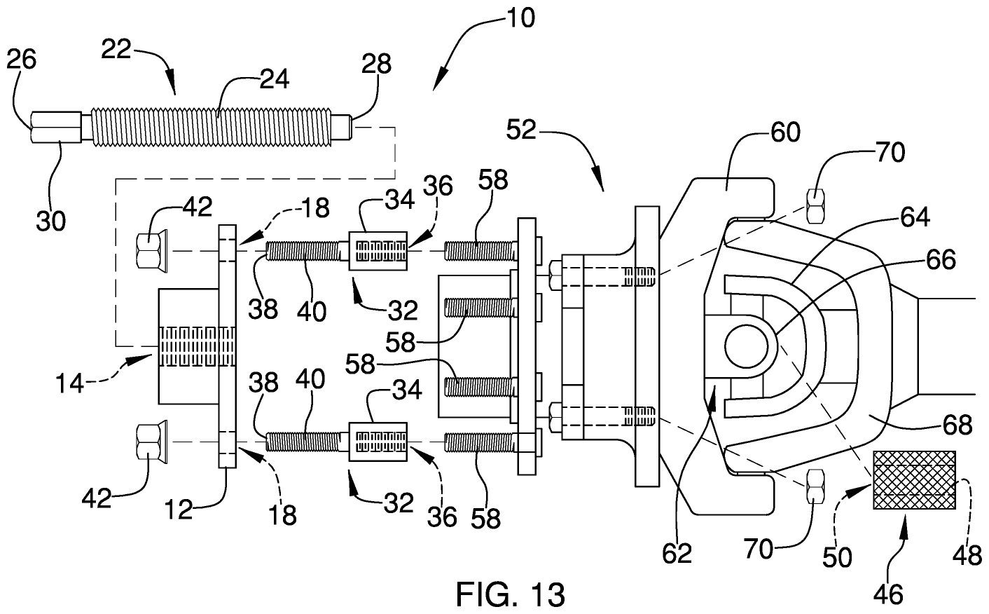

A pair of support blocks 46 is positionable between and in abutment with the stub axle 62 and an axle housing 68. With reference to FIGS. 13 through 15, the support blocks 46 are positioned to abut a U-joint 64 of the stub axle 62. Each support block 46 has a centering surface 48 which is shaped to center a contact surface 66 of the stub axle 62 on the support block 46. The Figures (e.g., FIG. 8) show a contact surface 66 that defines a channel 50 through the support block 46. When the contact surfaces 66 are placed in abutment with their respective support blocks 46, they extend into the channel 50 and are retained there by the support block 46. In other embodiments, the contact surfaces 66 may define recesses or may otherwise taper or converge such that the support block 46 does not slip out of engagement with the stub axle 62 during use. The support blocks 46 may have a cylindrical shape and a knurled or otherwise frictionally enhanced exterior to improve a grip on each support block 46.

In use, the hub removal device 10 is used to remove the hub assembly 52 from the steering knuckle 60 after hub assembly mounting nuts or other fasteners which secure the hub assembly 52 to the steering knuckle 60 are removed. The puller plate 12 is coupled to the studs 58 of the hub assembly 52 by threadedly coupling each of the stud extenders 32 to a corresponding stud 58 of the hub assembly 52, receiving the stud extenders 32 through the stud holes 18 in the puller plate 12, and threadedly coupling the nuts 42 to the stud extenders 32. The actuating rod 22 is screwed into the central hole 14 of the puller plate 12 and placed in abutment with the stub axle 62, which is coupled to the steering knuckle 60 via the axle housing 68. The pair of support blocks 46 are positioned between and in abutment with the stub axle 62 and the axle housing 68. Then, the actuating rod 22 is rotated via the driver tool 72 or other means to advance the actuating rod 22 through the central hole 14 and against the stub axle 62.

This action of the actuating rod 22 results in the actuating rod 22 urging the puller plate 12 away from the stub axle 62. The actuating rod 22 exerts a pressing force on the stub axle 62 which at least partially transmits through the support blocks 46 to the axle housing 68 instead of entirely through the U-joint 64. In this manner, a likelihood of damage to the U-joint 64 is minimized, and the stube axle is not urged to move further into the axle housing 68. The actuating rod 22 also causes the puller plate 12 to exert a pulling force on the studs 58 via the stud extenders 32 to pull the hub assembly 52 away from the steering knuckle 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hub removal device comprising:
a puller plate defining a central hole extending therethrough, the puller plate having internal threads in the central hole, the puller plate defining a plurality of stud holes which are radially spaced around the central hole, the plurality of stud holes being configured to align with studs of a hub assembly, the puller plate being configured to couple to the studs of a hub assembly; and
an actuating rod having external threads which are engageable with the internal threads of the central hole of the puller plate, the actuating rod having a first end and a second end.

2. The device of claim 1, wherein the actuating rod comprises a wrench engagement portion at the first end of the actuating rod shaped and configured to receive a torque from a driver tool to screw the actuating rod through the central hole of the puller plate.

3. The device of claim 2, wherein the wrench engagement portion has a hexagonal cross-section.

4. The device of claim 1, further comprising:
a plurality of stud extenders which are receivable through the stud holes of the puller plate, each stud extender having a receiver portion and an insertion portion that are coupled to and axially aligned with each other, the receiver portion of each stud extender having internal threads configured to threadedly engage a selected stud of the hub assembly, the insertion portion having external threads and being sized to be received through a selected one of the stud holes of the puller plate; and
a plurality of nuts which are threadedly engageable to the plurality of stud extenders to mount the puller plate to the stud extenders.

5. The device of claim 1, further comprising a support block configured to be positionable between and in abutment with the stub axle and an axle housing.

6. The device of claim 5, wherein the support block is one of a pair of support blocks, each support block having a centering surface shaped and configured to center a contact surface of the stube axle on the support block.

7. The device of claim 6, wherein the centering surface defines a channel which extends through the support block.

8. The device of claim 1, wherein the plurality of stud holes is configured to alternately align with studs of different hub assemblies which have different radial spacings around central axes of their respective hub assemblies, the puller plate being configured to couple to the studs of either one of the different hub assemblies.

9. The device of claim 8, wherein the plurality of stud holes includes a set of slots which are elongated radially around the central hole.

10. The device of claim 8, further comprising:
a plurality of stud extenders which are receivable through the stud holes of the puller plate, each stud extender having a receiver portion and an insertion portion that are coupled to and axially aligned with each other, the receiver portion of each stud extender having internal threads configured to threadedly engage a selected stud of one of the different hub assemblies, the insertion portion having external threads and being sized to be received through a selected one of the stud holes of the puller plate; and
a plurality of nuts which are threadedly engageable to the plurality of stud extenders to mount the puller plate to the stud extenders.

11. The device of claim 10, wherein the plurality of stud extenders including multiple subsets of stud extenders, each stud extender of each subset of stud extenders being configured to couple to one of the studs of a corresponding hub assembly of the different hub assemblies.

12. The device of claim 8, further comprising a pair of support blocks configured to be positionable between and in abutment with the stub axle and an axle housing, each support block having a centering surface shaped and configured to center a contact surface of the stub axle on the support block.

13. The device of claim 12, wherein the centering surface defines a channel which extends through the support block.

14. A hub removal device comprising:
a puller plate defining a central hole extending therethrough, the puller plate having internal threads in the central hole, the puller plate defining a plurality of stud holes which are radially spaced around the central hole, the plurality of stud holes being configured to alternately align with studs of different hub assemblies which have different radial spacings around central axes of their respective hub assemblies, the plurality of stud holes including a set of slots which are elongated radially around the central hole;
an actuating rod having external threads which are engageable with the internal threads of the central hole of the puller plate, the actuating rod having a first end and a second end, the actuating rod comprising a wrench engagement portion at the first end of the actuating rod shaped and configured to receive a torque from a driver tool to screw the actuating rod through the central hole of the puller plate, the wrench engagement portion having a hexagonal cross-section;
a plurality of stud extenders which are receivable through the stud holes of the puller plate, each stud extender having a receiver portion and an insertion portion that are coupled to and axially aligned with each other, the receiver portion of each stud extender having internal threads configured to threadedly engage a selected stud of one of the different hub assemblies, the insertion portion having external threads and being sized to be received through a selected one of the stud holes of the puller plate, the plurality of stud extenders including multiple subsets of stud extenders, each stud extender of each subset of stud extenders being configured to couple to one of the studs of a corresponding hub assembly of the different hub assemblies;
a plurality of nuts which are threadedly engageable to the plurality of stud extenders to mount the puller plate to the stud extenders; and
a pair of support blocks configured to be positionable between and in abutment with the stub axle and an axle housing, each support block having a centering surface shaped and configured to center a contact surface of the stub axle on the support block, the centering surface defining a channel which extends through the support block.

15. A method of removing a hub assembly from a steering knuckle, the method comprising:
coupling a puller plate to studs of the hub assembly;
inserting an actuating rod through a central hole of the puller plate and through the hub assembly to a stub axle, wherein the actuating rod threadedly engages the puller plate, wherein the stub axle is coupled to the steering knuckle via an axle housing; and
rotating the actuating rod such that its threading engagement with the puller plate causes the actuating rod to urge the puller plate away from the stub axle, whereby the puller plate exerts a pulling force on the studs of the hub assembly away from the steering knuckle.

16. The method of claim 15, wherein the step of coupling the puller plate to the studs of the hub assembly further comprises:
threadedly coupling each of a plurality of stud extenders to a corresponding stud of a plurality of studs of the hub assembly;
receiving the plurality of stud extenders through stud holes in the puller plate; and
threadedly coupling a plurality of nuts to the plurality of stud extenders, thereby retaining the puller plate on the plurality of stud extenders.

17. The method of claim 15, further comprising:
positioning a support block between and in abutment with the stub axle and the axle housing;
whereby, during the step of rotating the actuating rod to urge the puller plate away from the stub axle, the actuating rod exerts a pressing force on the stub axle which is at least partially transmitted through the support block.

18. The method of claim 17, wherein the support block is one of a pair of support blocks, further comprising positioning both support blocks between the stub axle and the axle housing.

19. The method of claim 18, wherein the step of positioning both support blocks between the stub axle and the axle housing further comprises positioning the support blocks in abutment with a U-joint of the stub axle.

20. The method of claim 18, wherein each support block has a centering surface shaped to center a contact surface of the stub axle on the support block.
